(19) United States
(12) Patent Application Publication
(10) Pub. No.: US 2005/0097790 A1
(43) Pub. Date: May 12, 2005

(54) Identification marker generating apparatus, method, storage medium and computer data signal

(76) Inventor: Masaichi Sawada, Tokyo (JP)

Correspondence Address: MORRISON & FOERSTER LLP, 1650 TYSONS BOULEVARD, SUITE 300, MCLEAN, VA, 22102, US

(21) Appl. No.: 10/978,705

(22) Filed: Nov. 2, 2004

(30) Foreign Application Priority Data
Nov. 7, 2003 (JP) 2003-378769

(51) Int. Cl. G06K 19/00; G09F 3/10

(52) U.S. Cl. 40/299.01; 340/572.1; 235/487; 283/67

(57) ABSTRACT

A management computer receives designation of an identifier formed by symbols recorded in a symbolic data storing section and designation of an identifier arranging area of a symbol arranging area from a user terminal. Then, the management computer arranges the identifier in the identifier arranging area of the symbol arranging area. After that, the management computer extracts symbols, which belong to the same category where the symbols that form the identifier belong, from the symbolic data storing section, and arranges the extracted symbols in a portion excepting the identifier arranging area of the symbol arranging area, thereby generating data of the identification marker. Then, the management computer outputs data for printing the identification marker to an output device. In response to this, the output device prints the identification marker.

### BACKGROUND OF THE INVENTION

1. Field of the Invention

The present invention relates to an identification marker generating apparatus and method for generating an identification marker, a storage medium, and a computer data signal.

2. Description of the Related Art

In order to distinguish an owner's item from the other's item, there is a case in which owner's name is written thereto or owner's mark is added thereto. For example, as described in Unexamined Japanese Patent Application KOKAI Publication No. 2001-264892, there is a system in which paper on which an address and a name are printed is added to specify a client on receiving a request for printing a photograph, etc., so that the paper is provided to the client. However, such an explicit addition of owner's name or mark is unsuitable for a case in which the owner does not desire that his/her item is specified as his/her possession by the other person. Moreover, when owner's name or mark is known by the other person, there is a possibility that the other person will add his/her name to the item to abuse.

On the other hand, there is a case in which a pattern is added to a ticket and the like in order to prevent forgery. Moreover, for example, as described in Unexamined Japanese Patent Application KOKAI Publication No. 2000-59610, there is provided a technique for embedding data to a predetermined identifier using the digital watermarking in connection with image data, etc. This technique is one in which information that cannot be cognized even by reproduction using a general method is embedded to image data and the like to prevent the image from being illegally copied.

However, in the case of using the sophisticated identifying technique such as the digital watermarking, correctness cannot be determined unless the computer and the like are used.

### SUMMARY OF THE INVENTION

The present invention has been made in consideration of the aforementioned circumstances, and an object of the present invention is to provide an identification marker generating apparatus and method that can generate an identification marker that is difficult for the other person to identify though an owner can easily identify his/her item at sight.

In order to attain the above object, an identification marker generating apparatus according to a first aspect of the present invention includes an identifier designating section that receives designation of an identifier formed by symbols. The identifier marker generating apparatus further includes an identifier arranging area designating section that receives designation of an identifier arranging area of a symbol arranging area. The identifier marker generating apparatus further includes an arranging section that arranges the designated identifier in the designated identifier arranging area of the symbol arranging area. The identifier marker generating apparatus further includes an extracting section that extracts symbols belonging to the same category where the symbols that form the identifier belong from a database where the symbols belonging to the same category are stored to be associated with each other. The identifier marker generating apparatus further includes a generating section that generates an identification marker by arranging the extracted symbols in a portion excepting the identifier arranging area of the symbol. The identifier marker generating apparatus further includes an outputting section that outputs the generated identification marker.

Moreover, an identification marker generating apparatus according to a second aspect of the present invention includes identifier designating means for receiving designation of an identifier formed by symbols. The identifier marker generating apparatus further includes identifier arranging area designating means for receiving designation of an identifier arranging area of a symbol arranging area. The identifier marker generating apparatus further includes arranging means for arranging the designated identifier in the designated identifier arranging area of the symbol arranging area. The identifier marker generating apparatus further includes an extracting means for extracting symbols belonging to the same category where the symbols that form the identifier belong from a database where the symbols belonging to the same category are stored to be associated with each other. The identifier marker generating apparatus further includes generating means for generating an identification marker by arranging the extracted symbols in a portion excepting the identifier arranging area of the symbol arranging area. The identifier marker generating apparatus further includes outputting means for outputting the generated identification marker.

Moreover, an identification marker generating method according to a third aspect of the present invention is an identification marker generating method for generating data of an identification marker including an identifier using a computer. The identification marker generating method receives designation of an identifier formed by symbols. The identification marker generating method further receives designation of an identifier arranging area of a symbol arranging area. The identification marker generating method further arranges the designated identifier in the designated identifier arranging area of the symbol arranging area. The identification marker generating method further extracts symbols belonging to the same category where the symbols that form the identifier belong from a database where the symbols belonging to the same category are stored to be associated with each other. The identification marker generating method further generates an identification marker by arranging the extracted symbols in a portion excepting the identifier arranging area of the symbol arranging area. The identification marker generating method further outputs the generated identification marker.

Moreover, a computer-readable storage medium according to a fourth aspect of the present invention has a program recorded thereon. The program causes a computer to execute the step of receiving designation of an identifier formed by symbols. The program further causes a computer to execute the step of receiving designation of an identifier arranging area of a symbol arranging area. The program further causes a computer to execute the step of arranging the designated identifier in the designated identifier arranging area of the symbol arranging area. The program further causes a computer to execute the step of extracting symbols belonging to the same category where the symbols that form the identifier belong from a database where the symbols belonging to the same category are stored to be associated with each other. The program further causes a computer to execute the step of generating an identification marker by arranging the extracted symbols in a portion excepting the identifier arranging area of the symbol arranging area. The program further causes a computer to execute the step of outputting the generated identification marker.

Moreover, a computer data signal embedded in a carrier wave according to a fifth aspect of the present invention indicates a program. The program causes a computer to execute the step of receiving designation of an identifier formed by symbols. The program further causes a computer to execute the step of receiving designation of an identifier arranging area of a symbol arranging area. The program further causes a computer to execute the step of arranging the designated identifier in the designated identifier arranging area of the symbol arranging area. The program further causes a computer to execute the step of extracting symbols belonging to the same category where the symbols that form the identifier belong from a database where the symbols belonging to the same category are stored to be associated with each other. The program further causes a computer to execute the step of generating an identification marker by arranging the extracted symbols in a portion excepting the identifier arranging area of the symbol arranging area. The program further causes a computer to execute the step of outputting the generated identification marker.

### BRIEF DESCRIPTION OF THE DRAWINGS

These objects and other objects and advantages of the present invention will become more apparent upon reading of the following detailed description and the accompanying drawings in which:

FIG. 1 is a view illustrating a configuration example of a printing system according to a first embodiment of the present invention;

FIG. 2 is a view illustrating a hardware configuration of a management computer used in the printing system of FIG. 1;

FIG. 3 is a view illustrating a data configuration example of a symbol group data;

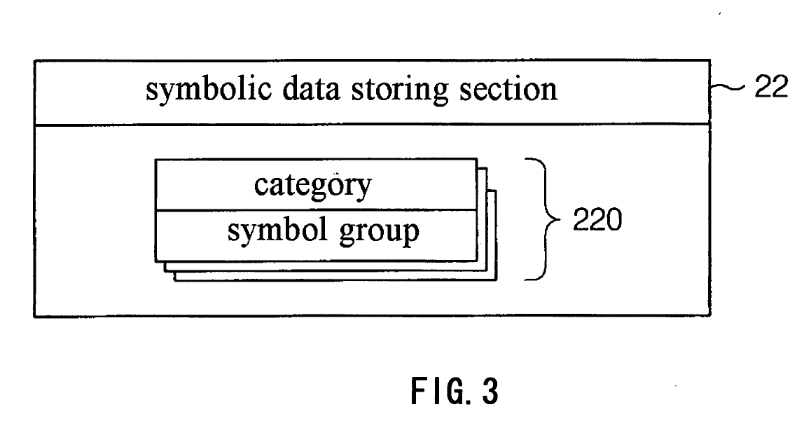

FIG. 4 is a flowchart illustrating an identification marker generation processing;

FIG. 5 is a view illustrating one example of an identification designation screen;

FIG. 6 is a view illustrating one example of a designation screen;

FIG. 7 is a view specifically illustrating processing for placing an identifier to a symbol arranging area;

FIG. 8 is a view specifically explaining processing for placing an identifier to a symbol arranging area;

FIG. 9 is a view illustrating a configuration example of a printing system according to a second embodiment of the present invention;

FIG. 10 is a view illustrating a hardware configuration of a management computer used in the printing system of FIG. 9;

FIG. 11 is a view illustrating a data configuration example of user data;

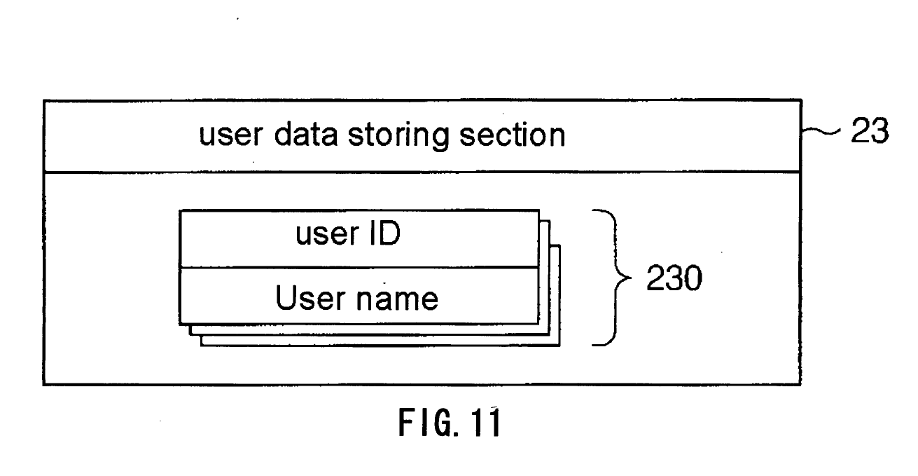

FIG. 12 is a view illustrating a data configuration example of output destination data;

FIG. 13 is a view illustrating a data configuration example of reception data;

FIG. 14 is a view illustrating a configuration of a document output device;

FIG. 15 is a flowchart illustrating a printed matter generation processing; and

FIG. 16 is a flowchart illustrating print processing.

### DETAILED DESCRIPTION OF THE PREFERRED EMBODIMENTS

The following will explain embodiments of the present invention with reference to the drawings.

### First Embodiment

A first embodiment explains a printing system that generates an identification marker in which an identifier including symbols designated by a user is embedded. The system according to the present embodiment generates an identification label on which an identification marker having an identifier embedded therein is printed and provides the generated identification label to the user.

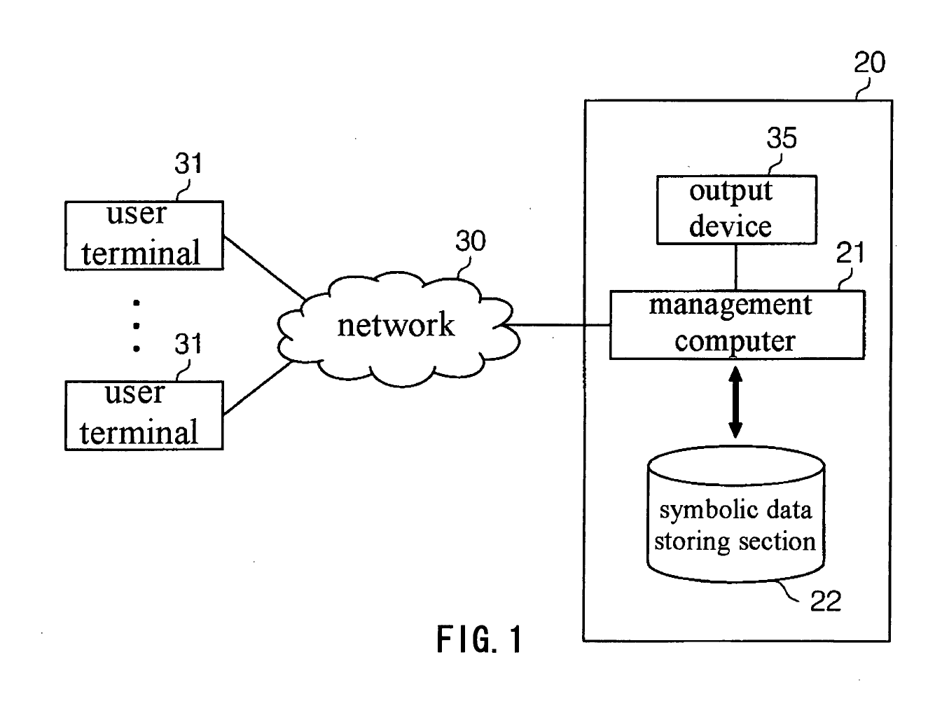

As illustrated in FIG. 1, a printing system 20 is connected to a user terminal 31 via a network 30 such as the Internet and the like. The user gains access to the printing system 20 using the user terminal 3 land receives the identification label on which the identification marker is printed.

The user terminal 31 includes a computer having a control section such as a CPU, etc., a storing section such as a RAM, a ROM, a hard disk, etc., an input section such as a keyboard, a mouse, etc, a display section such as a display, etc., and a communications section such as a modem, etc. The control section of the terminal user 31 reads a program stored in the storing section and executes the program, thereby achieving a function of transmitting data via the network and a function of displaying received data.

The printing system 20 performs various kinds of data processing for printing the identification label including the symbols designated by the user is embedded. The printing system 20 includes a management computer 21, a symbolic data storing section 22, and an output device 35. The management computer 21 is connected to the symbolic data storing section 22 and the output device 35.

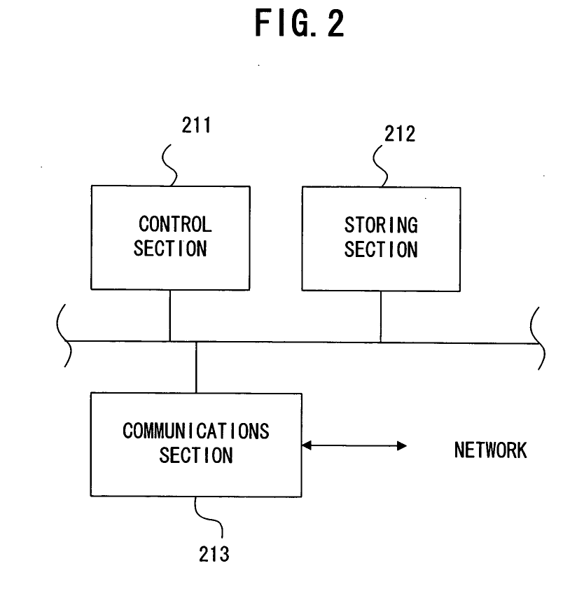

The management computer 21 performs data transmission and reception between each user terminal 31 and the management computer 21 and data management processing for managing various kinds of data. As illustrated in FIG. 2, the management computer 21 includes a control section 211 having a CPU, a RAM, a ROM, etc, a storing section 212 having a hard disk, etc, and a communications section 213 that controls communications with the other apparatus via the network. The control section 211 executes a program stored in the storing section 212, thereby implementing an identifier designating section, an identifier arranging area designating section, an arranging section, an extracting section, a generating section, and an outputting section. The identifier designating section receives the designation of the identifier having symbols. The identifier arranging area designating section receives the designation of an identification arranging area in a symbol arranging area. The arranging section arranges the designated identifier in the designated identifier arranging area. The extracting section extracts symbols, which belong to the same category where the symbols that form the identifier belong, from a database (symbolic data storing section 22) to be associated with each other. The generating section generates an identification marker by arranging the extracted symbols in a portion other than the identification arranging area in the symbol arranging area. The outputting section outputs the generated identification marker.

The symbolic data storing section 22 is a database in which symbol group data 220 where symbols usable as an identifier are sorted for each category is recorded. The symbol group data 220 includes category data and symbol group data. In the area of category data, data indicating a category of symbols is recorded. In the area of symbol group data, data indicating a symbol belonging to the category shown by category data is recorded. In the present embodiment, the symbols usable as an identifier are classified into categories such as alphabetical characters (capital letters) and alphabetical characters (small letters), Greek alphabets (capital letters), and Greek alphabets (small letters), and general symbols. Then, a set of symbols belonging to these categories is recorded in the area of symbol group data. For example, when the category is “alphabetical characters (capital letters)”, data relating to the respective symbols of “A, B, C, . . . ” is recorded in the area of symbol group data corresponding to this category data.

The output device 35 includes, for example, a printer, and performs print processing based on a print request transmitted from the management computer 21. The output device 35 performs print processing based on the print request transmitted from the management computer 21. The output device 35 includes a control section having CPU, etc., a storing section having a ROM, a RAM, etc., a communications section, and an input section. Additionally, the printing section may have a mechanism that gets an envelope from an envelope storing area to enclose a printed matter.

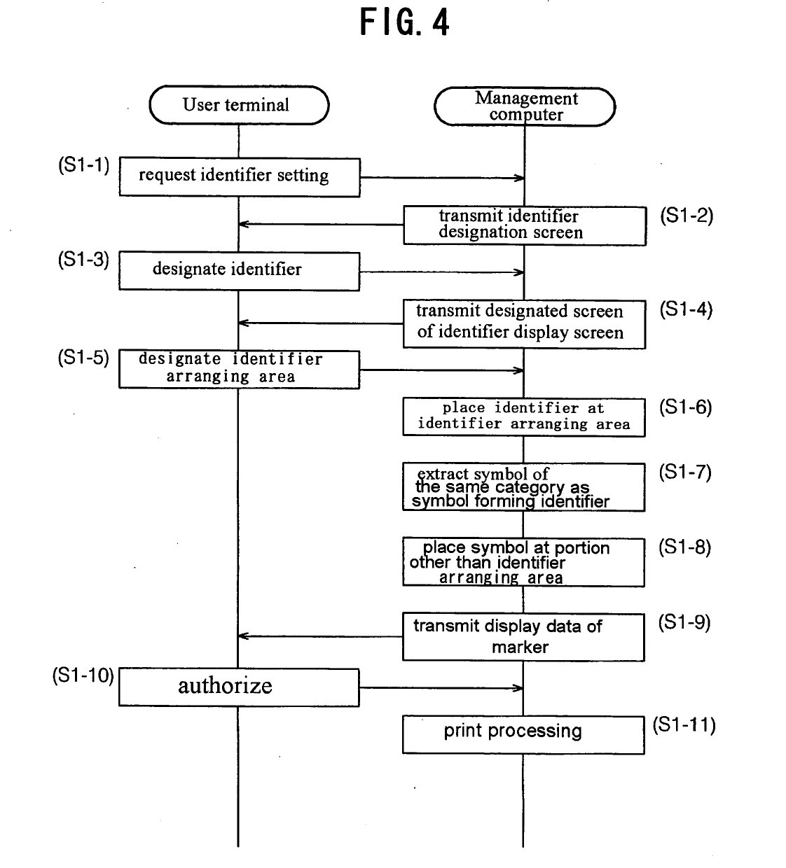

An explanation will be next given of processing in which an identification marker is printed to generate an identification label in the printing system 20 with reference to FIGS. 4 to 8.

First of all, the user gains access to the management computer 21 using the user terminal 31 to apply for using identification label printing service. In response to this request, the control section 211 of the management computer 21 transmits data of an application screen to the user terminal 31. The application screen includes an input field for user address and name as a print label delivery address. The user inputs his/her address and name on the application screen and performs an operation for instructing transmission. In accordance with this operation, the user terminal 31 transmits an identification setting request to the management computer 21 as illustrated in FIG. 4 (step S1-1). The identification setting request includes input data of user address and name. The control section 211 of the management computer 21, which has received the identifier setting request, records the received data of user address and name on the storing section 212, and transmits data on an identifier designation screen to the user terminal 31 (step S1-2).

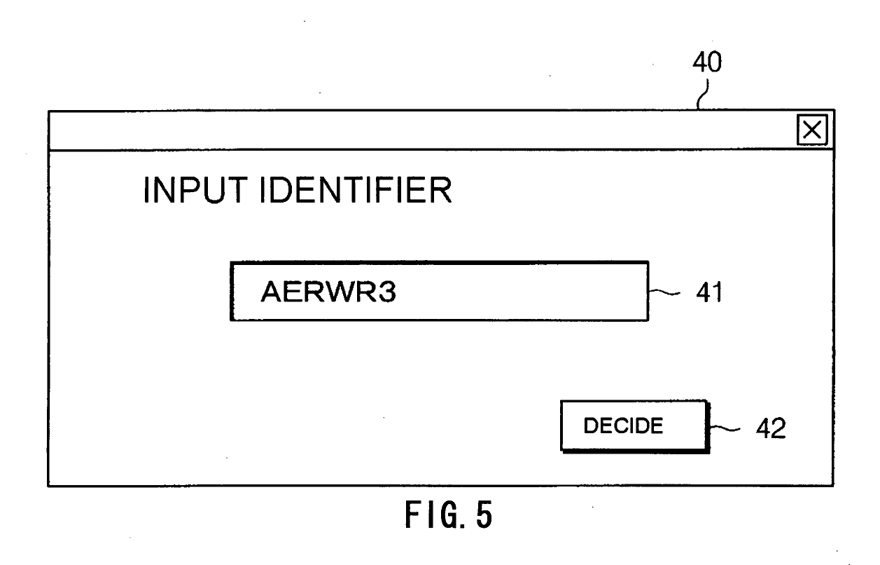

The user terminal 31, which has received data on the identification designation screen, displays an identification designation screen 40 as illustrated in, for example, FIG. 5. The identification designation screen 40 includes an identifier input field 41 and a decision button 42. In the identifier input field 41, the user designates an identifier using the input section such as a keyboard of the user terminal 31. In the example of FIG. 5, the user inputs “AERWR3” as an identifier. In response to the fact that the decision button 42 is clicked on the identifier designation screen 40, the user terminal 31 transmits data of the designated identifier to the management computer 21 (step S1-3).

The control section 211 of the management computer 21, which has received data of the identifier, transmits data on the designation screen for designating an identifier arranging position to the user terminal 31 (step S1-4).

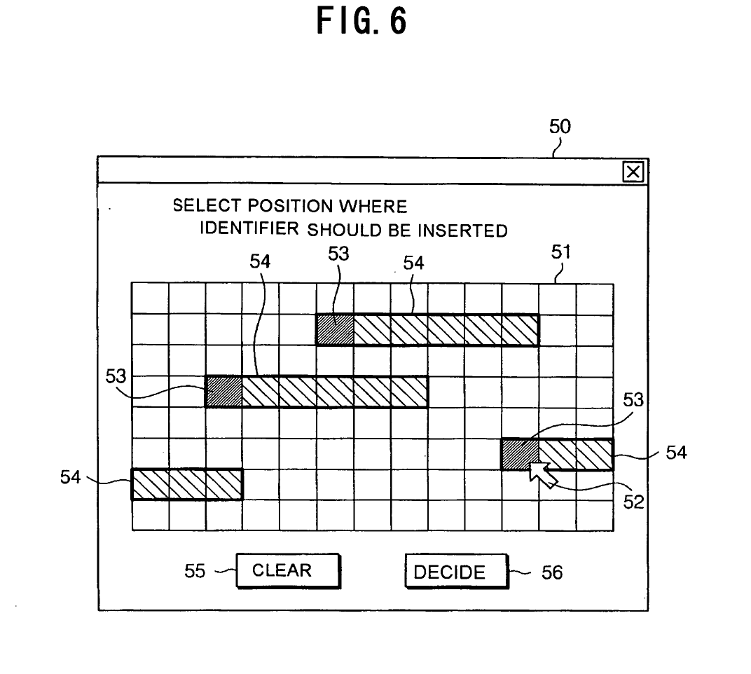

The user terminal 31, which has received data on the designation screen, displays a designation screen 50 as illustrated in, for example, FIG. 6. On the designation screen 50, multiple squares corresponding to a symbol arranging range (symbol arranging area) are displayed. One symbol is set to one square. The user moves a pointer 52 using the mouse and the like to designate an area indicating the identifier. An identification arranging area designation method is arbitrarily set. For example, in response to receiving a designation of a square (start position 53) to which a first symbol of the identifier is to be set, the user terminal 31 decides the number of squares, which is continuous from the square of the position and has the same number as the number of symbols that forms the identifier as an identifier arranging position (identifier arranging area) 54, and changes a display color of the square of the identifier arranging area 54. When “AERWR3” is designated as an identifier, the number of symbols that forms the identifier is “6”, so that six squares, which are continuous from the square of a designated start position 53, is selected as the identifier arranging area 54.

Moreover, the designation screen 50 has a clear button 55 and a decision button 56. The clear button 55 is used to reselect the identifier arranging area 54. When the clear button 55 is clicked, the setting of the selected identifier arranging area 54 is cancelled to make it possible to reselect the identifier arranging area 54 from the beginning. The decide button 55 is used to determine the designation of the identifier arranging area 54. When the identifier arranging area 54 is designated and the decision button 56 is clicked, the user terminal 31 transmits data indicating the identifier arranging area to the management computer 21 (step S1-5).

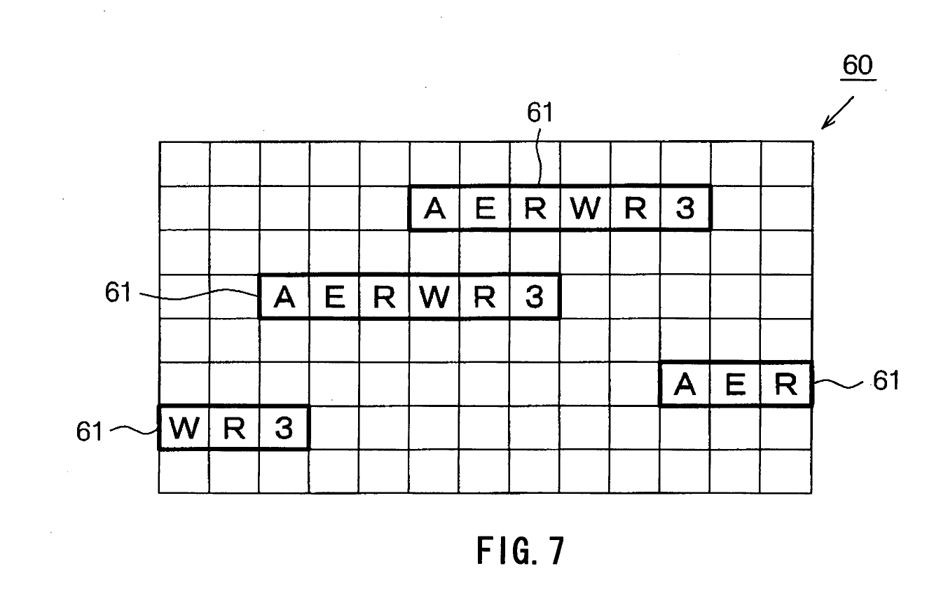

When receiving data indicating the identifier arranging area 54 from the user terminal 31, the control section 221 of the management computer 21 arranges the designated identifier in the designated identifier arranging area of the symbol arranging area based on data indicating the identifier received from the user terminal 31 and data indicating the identifier arranging area (step S1-6). In an example illustrated in FIG. 7, in a symbol arranging range (symbol arranging area) 60, a designated identifier “AERWR3” is arranged in a designated identifier arranging area 61.

Next, the control section 211 of the management computer 21 extracts a symbol, which belongs to the same category where the symbols that form the designated identifier belongs, from the symbolic data storing section 22 (step S1-7). More specifically, in connection with each symbol that forms the designated identifier, the control section 211 of the management computer 21 first searches the symbol group of symbol group data 220 of the symbolic data storing section 22 and extracts data of the category where the symbol belongs. Then, the control section 211 calculates a ratio of the category extracted in connection each symbol used in the designated identifier. Furthermore, the control section 211 obtains the number of symbols that can be set in an area excepting the identifier arranging area 61 in the symbol arranging area 60, and calculates the number of extracting symbols from each category based on the obtained number of symbols and the calculated ratio. Then, the control section 211 randomly extracts the number of calculated symbols in each category from the symbol group data 220 of each category.

For example, in the case where the designated identifier is “AERWR3”, the category where “A, E, R, W, R” belongs is “alphabetical characters (capital letters).” Moreover, the category where “3” belongs is a “numeral.” Then, a ratio between “alphabetical characters” and “numeral” is 5:1. Accordingly, the control section 211 randomly extracts the number of symbols corresponding to the area excepting the identifier arranging area 61 in the symbol arranging area 60 from the symbol group data 220 where the category is “alphabetical characters” and the symbol group data 200 where the category is “numeral” at a ratio of 5:1.

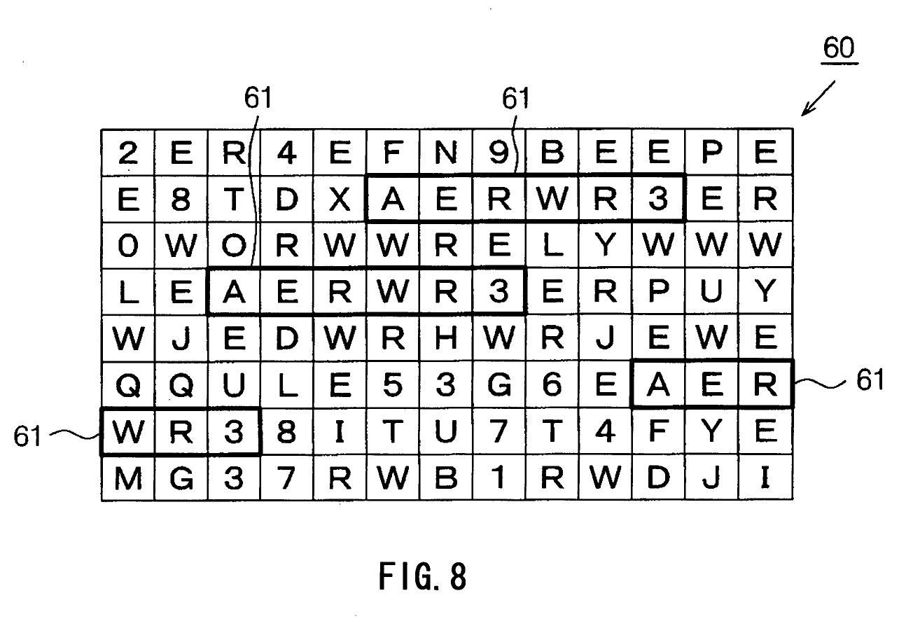

After that, the control section 211 of the management computer 21 arranges the symbols, which belong to the same category where the symbols that form the identifier belong, in a portion excepting the identification arranging area of the symbol arranging area, thereby generating an identification marker (step S1-8). More specifically, the control section 211 randomly arranges the symbols extracted from the symbolic data storing section 22 in the portion excepting the identification arranging area 51 of the symbol arranging range 60 as illustrated in, for example, FIG. 7. Accordingly, data of the identification marker is generated as illustrated in FIG. 8.

Then, the control section 211 of the management computer 21 transmits data for displaying the generated identification marker to the user terminal 31 (step S1-9). The user terminal 31 that has received the data displays a screen including the symbol arranging area 60 (identification marker) where the identifier and the other symbols are arranged and an approval button. The user performs an approval input using the approval button in order to confirm the symbol arranging area 60 (identification marker) and approve the result on the display screen. Accordingly, the user terminal 31 transmits approval data indicating approval of the symbol arranging range 60 to the management computer 21 (step S1-10).

Then, the control section 211 of the management computer 21, which has received approval data, performs processing for printing the identification label including the symbol arranging area 60 (identifier marker) where the identifier and the other symbols are arranged (step S1-11). In the present embodiment, the control section 211 sends a request for printing an identification marker to the output device 35 and the output device 35 prints the identification marker on a predetermined label paper. Furthermore, in step S1-1, the control section 211 of the management computer 21 reads data of the user address and name recorded after being received from the user terminal 31, and transmits data to the output device 35 to make a request for printing a delivery envelope. Accordingly, the output device 35 may operate in such a way to enclose the identification label on which the identification marker corresponding to the symbol arranging area 60 is printed in the delivery envelope extracted from a predetermined storing section. In this case, the operator of the printing system 20 mails the envelope on which the identification marker is printed to the user.

As mentioned above, according to the present invention, the following effects can be obtained.

In the aforementioned embodiment, the management computer 21 receives the designation of the identifier formed by the symbols and the designation of the identifier arranging area of the symbol arranging area and arranges the identifier of the identifier arranging area of the symbol arranging area. Then, the management computer 21 extracts the symbols belonging to the same category where the symbols that form the identifier from the symbolic data storing section 22, arranges the extracted symbols in the portion excepting the identifier arranging area of the symbol arranging range, and generates the identification marker including the identifier to output. This makes it possible to arrange the designated identifier in the designated identifier arranging area and generate an identification marker where the identifier is embedded in the symbols belonging to the same category where the identifier belongs. Accordingly, the user, who has designated the identifier and the identifier arranging area, can easily confirm the identifier at sight from a visual point of view, and makes it difficult for other persons to grasp the identifier. Moreover, the identifier is embedded in the symbols belonging to the same category where the symbols that form the designated identifier belong, thereby making it more difficult for other persons to grasp the identifier.

In the aforementioned embodiment, the number of symbols that form the identifier is arbitrarily set, and the management computer 21 specifies the position where the identifier is placed according to the number of symbols that form the identifier. For this reason, the user can designate the identifier including the predetermined number of symbols.

In the aforementioned embodiment, the management computer 21 receives the designation of the multiple identifier arranging areas and arranges the identifier in the designated multiple identifier arranging areas. Accordingly, the identifier can be embedded in the designated multiple identifier arranging areas in the symbol arranging range.

In the aforementioned embodiment, the symbols that form the identifier are classified for each category, and the identifier is embedded in the symbols belonging to the same category where the symbols that form the identifier belong. Moreover, the ratio of symbols to be arranged in the portion excepting the identifier arranging area is decided according to the ratio of the symbols that form the identifier for each category. This makes it more difficult for the other persons to grasp the identifier and its position.

In the aforementioned embodiment, the designated identifier is arranged in the designated identifier arranging area. Then, the identification marker where the identifier is embedded in the symbols belonging to the same category where the identifier belongs is printed on the label. Accordingly, the user designates the identifier and the identifier arranging area to make it possible to gain the identification label, which is the printed matter on which the identification marker is printed.

### Second Embodiment

The following explains a second embodiment of the present invention. The present embodiment explains a printing system that packs a printed matter that is prepared based on a print request sent from a user terminal and provides the package in such a way to be identified by an identification marker.

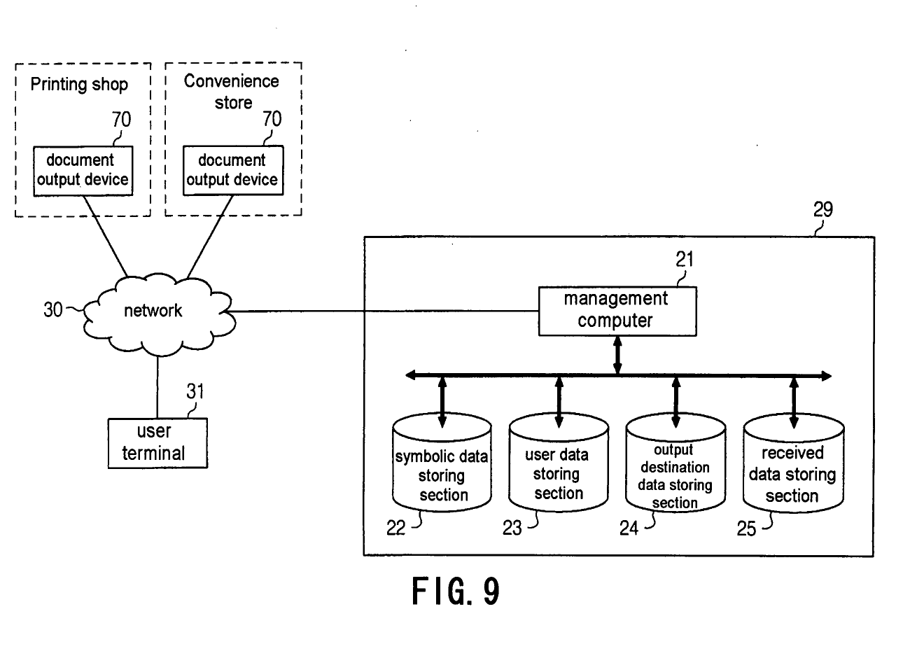

As illustrated in FIG. 9, the printing system according to the second embodiment includes a print management system 29, a user terminal 31, and a document output device 70. The print management system 29 is connected to the user terminal 31 and the document output device 70 via a network 30 such as the Internet and the like. The document output device 70 has a packing function and is set up at the stores such as a printing shop, a convenience sore, etc. The document output device 70 is connected to the print management system 29 and the user terminal 31 via the network 30.

The user terminal 31 has the same function and configuration as those of the first embodiment.

The document output device 70 receives print data from the print management system 29 and performs printing. The document output device 70 has a specific IP address. When receiving print data from the print management system 29, the document output device 70 stores the print data. When an output request is input from an input section of the document output device 70, the document output device 70 executes printing and packs an output printed matter.

The print management system 29 includes a management computer 26 and the respective databases (symbolic data storing section 22, user data storing section 23, output destination data storing section 24, and reception data storing section 25) as illustrated in FIG. 9. The management computer 26 is connected to the respective databases 22 to 25.

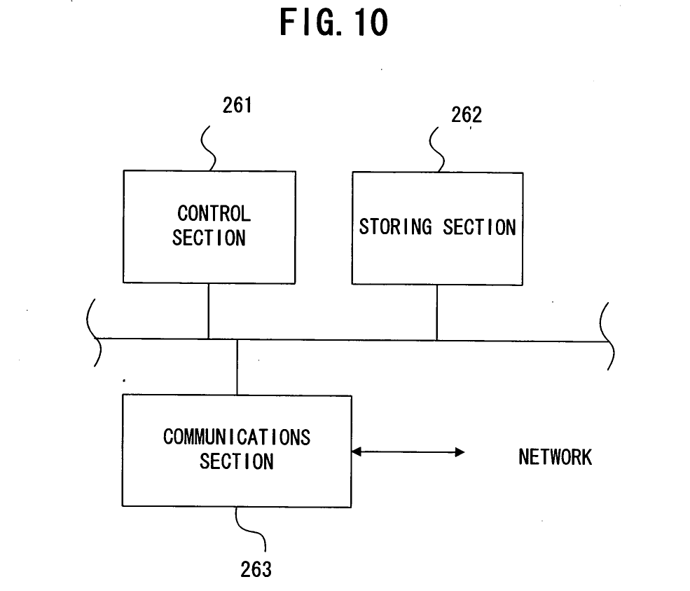

The management computer 26 receives print data from the user terminal 31, searches the document output devices 70, and transmits print data to which a reception number is added to the document output device 70 selected from the searched document output devices 70 by the user. For example, as illustrated in FIG. 10, the management computer 26 includes a control section 261 having a CPU, a RAM, a ROM, etc., a storing section 262 having a hard disk, etc, and a communications section 263 that controls communications with the other apparatus via the network. The control section 261 executes a program stored in the storing section 262, thereby implementing an identifier designating section, an identifier arranging area designating section, an arranging section, an extracting section, a generating section, and an outputting section.

Symbol group data 220 where symbols usable as an identifier are sorted for each category is recorded in the symbolic data storing section 22, similar to the first embodiment.

User data 230 relating to the user is recorded in the user data recording section 23 for each user as illustrated in FIG. 23. The user data 230 is recorded when the user executes predetermined registration processing for receiving the service of the present embodiment. The user data 230 includes data of a user ID and a user name. Data of an identifier for identifying a user is recorded in a data area of the user ID. Data of the user name is recorded in a data area of the user name.

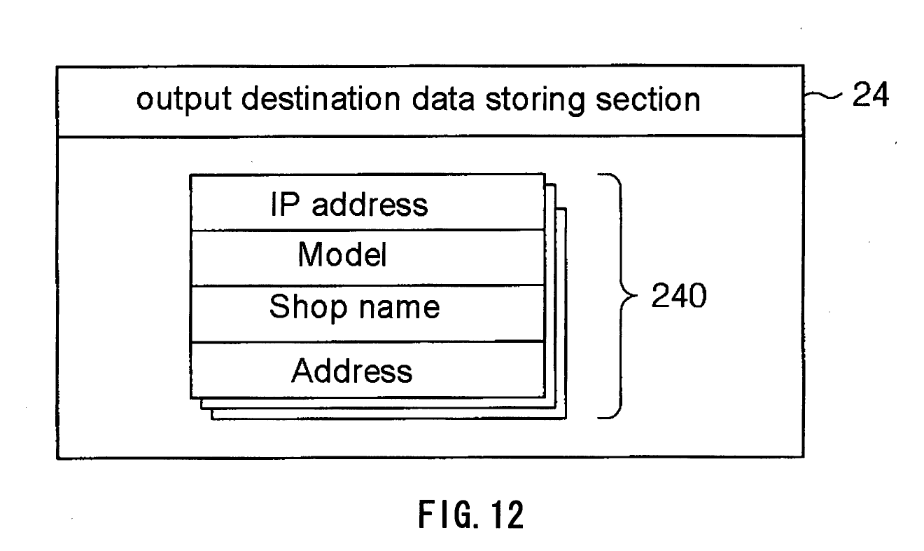

As illustrated in FIG. 12, the output destination data 240 is recorded in the output destination data storing section 24 for each document output device 70. The output destination data 240 is recorded when predetermined registration processing of the document output device 70 is executed to provide a print support service to the store. The output destination data 240 includes an IP address, a model, a store name and an address. In an area of the IP address, data of the IP address on the network 30 of the document output device 70 is recorded. In an area of model data, data of the model of the document output device 70 is recorded. In an area of store name data, data of the name of store where the document output device 70 is set up is recorded. In an area of address data, data of latitude and longitude of the address at which the store is set up is recorded.

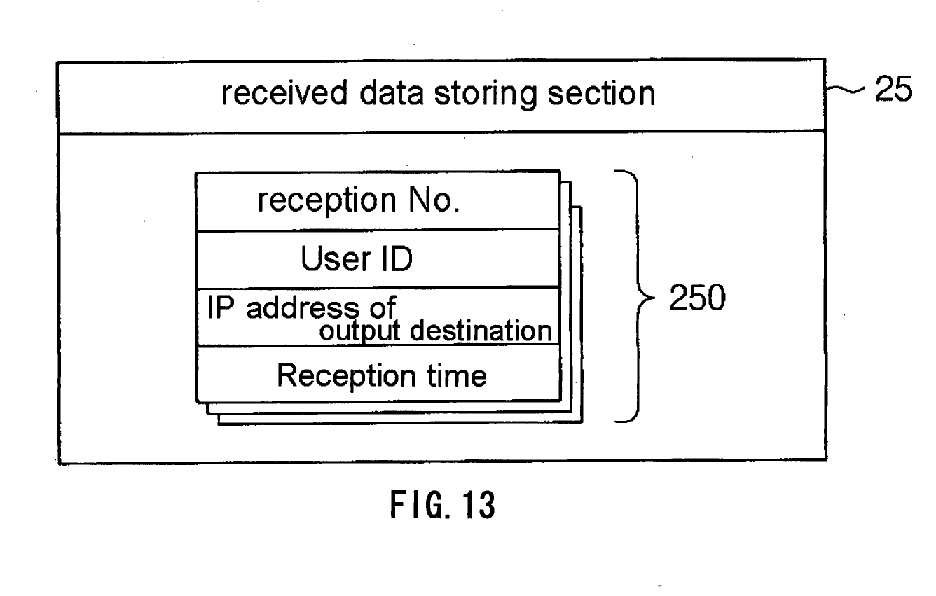

As illustrated in FIG. 13, reception data 250 for each received print request is recorded in the reception data storing section 25. The reception data 250 is recorded when the management computer 26 transmits print data to the selected document output device 70. The reception data 250 includes data of a reception number, a user ID, an IP address of an output destination and reception time. In a data area of the reception number, data of an identifier for identifying a print request through the print management system 29 is recorded. In a data area of the IP address of the output destination, an IP address of an output destination is recorded. In a data area of reception time, data of date and time when selection data for selecting the document output device 70 is recorded.

(Configuration of Document Output Device 70)

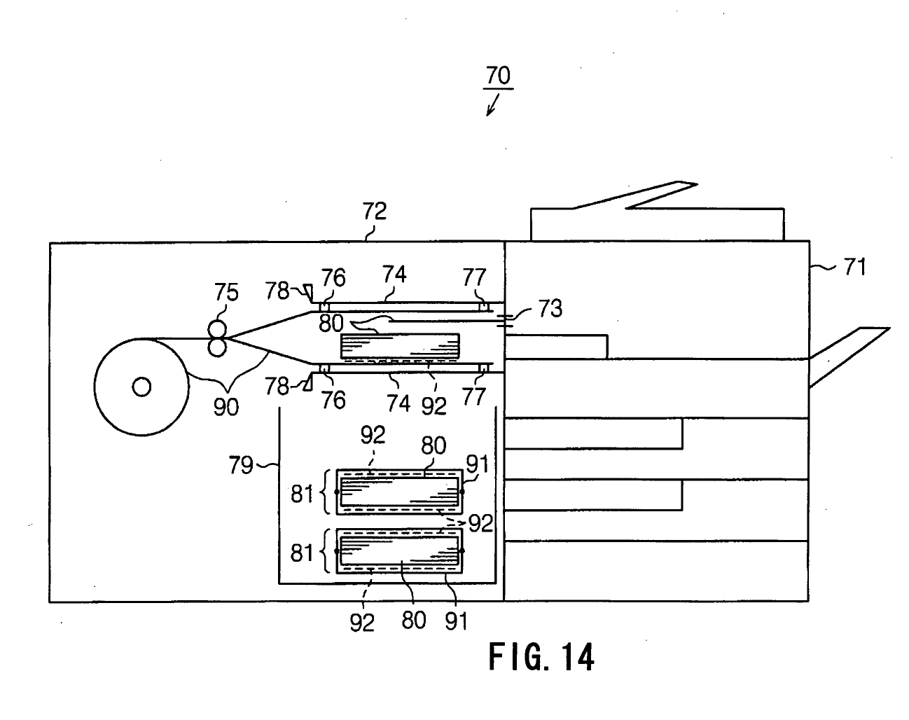

As illustrated in FIG. 14, the document output device 70 includes a printing device 71 and a packing device 72. The document output device 70 has the respective functions as a general printer and an MFP (Multi Function Peripheral). Namely, the printing device 71 includes a control section having a CPU etc., a storing section having a RAM, a ROM, etc, and a communications section, and an input section. Moreover, the printing device 71 operates in such a way to discharge output paper 80 to a packing material 90 spread in a paper mounting section 74 of the packing device 72 from a discharge port 73.

In the packing device 72, the packing material 90, which is formed by winding tube-like vinyl material in a roll form, is supported in parallel with the discharge port 73 of the printing device 71. A control section of the packing device 72 controls each delivering mechanism such as a feeding roller 75 and the like to deliver the packing material 90 to the discharge port 73 of the printing device 71 as opening its top end in the paper mounting section 74. Then, as described later, the packing material 90 is fixed with the top end opened, so that the output paper 80 can be fed from the discharge port 73. The packing device 72 includes a pair of feeding rollers 75 that delivers the packing material 90 from the roll of the packing material 90 to feed into the paper mounting section 74. The feeding rollers 75 sandwich the tube-like packing material 90. Then, the feeding rollers 75 gradually draw the packing material 90 supported in a roll manner to be sent to the paper mounting section 74.

Furthermore, a pair of nozzles opposing to each other to sandwich the packing material 90 is fixed to the paper mounting section side of the feeding rollers 75, and airflow is discharged from the nozzles. Additionally, Unexamined Japanese Patent for Application KOKAI Publication No. 11-115908 discloses a mechanism in which airflow is discharged from nozzles to send a tube-like bag material to a cylindrical member as opening its top end of the bag material. In the present embodiment, the bag material corresponds to the packing material 90 and the cylindrical member corresponds to the paper mounting section 74. Then, the feeding rollers 75 send the packing material 90 to the paper mounting section 74 as opening the top end of the packing material 90 by airflow discharged from the nozzles. In this case, at the time the roll-form packing material 90 is set to the feeding rollers 75, the top end portion of the packing material 90 is opened a little to introduce air thereinto. When the packing material is sandwiched by the feeding rollers 75 in this way, air sealed therebetween forms air reservoir and functions to once open the packing material 90 passing through the feeding rollers 90. Then, the feeding rollers 75 are driven to deliver the roll-like packing material 90 to send into the paper mounting section 74. Moreover, airflow is blown from the nozzles to open the top end of the packing material 90 to be fed. Then, the packing material 90 is transferred to the discharging port 73 along an inner wall surface of the paper mounting section 74.

At the feeding roller side of the paper mounting section 74, there is provided a pair of first heaters 76 extending in a direction perpendicular to a longitudinal direction of the packing material 90. The first heaters 76 come close to each other or separate from each other by a first heater motor. The first heaters 76 heat the packing material 90 in a state that the packing material 90 is interposed therebetween, so that the packing material 90 can be bound in a direction perpendicular to the longitudinal direction. Moreover, in the vicinity of the first heaters 76, a first sucking section to which negative pressure is supplied by control of the control section packing device 72 is provided. When the negative pressure is supplied to the first sucking section, the packing material 90 is supported to be sucked by the first sucking section. The first sucking section is structured to be moved with the first heaters 76. A pair of cutters 78 is supported between the first heaters 76 and the feeding rollers 75 to sandwich the packing material 90 therebetween. The cutters 78 are supported to be reciprocated in such a way that they come close to each other or separate from each other. The edges of the cutters 78 are directed inwardly. When each of the cutters 78 is driven by a cutter drive motor, the edge digs into the packing material 90 to cut. Thereafter, the cutter 78 separates therefrom to move backward.

At the discharge port side of the paper mounting section 74, there is provided a pair of second heaters 77 extending in a direction perpendicular to a longitudinal direction of the packing material 90. The first heaters 77 come close to each other or separate from each other by a second heater motor. The second heaters 77 heat the packing material 90 in a state that the packing material 90 is interposed therebetween, so that the packing material 90 can be bound in a direction perpendicular to the longitudinal direction. Moreover, in the vicinity of the first heaters 77, a second sucking section to which negative pressure is supplied by control of the control section packing device 72 is provided. When the negative pressure is supplied to the second sucking section, the packing material 90 is supported to be sucked by the second sucking section. The second sucking section is structured to be moved with the second heaters 77.

In the present embodiment, the output paper 80 is packed in such a way that output paper 80 of the uppermost layer and output paper 80 of the lowest layer are respectively combined with the packing material 90. In the present embodiment, the output paper 80 of the uppermost layer and the output paper 80 of the lowest layer are respectively combined with the packing material 90 by thermocompression bonding. For this reason, the packing device 72 has a thermocompression bonding section for thermocompression bonding the output paper 80 of the uppermost layer and output paper 80 of the lowest layer among the output paper 80 discharged to the paper mounting section 74 to the packing material 90, respectively. In the present embodiment, the packing material 90 and the output paper 80 are bonded to each other using a thermocompression bonding film. A hot-melt adhesive, which is melt on contacting matter by heating to a predetermined temperature, is applied on an outer surface of both sides of the thermocompression bonding film. The thermocompression bonding film is stored in a thermocompression bonding film storing section of the printing device 71 and discharged to the paper mounting section 74.

When the document output device 70 discharges the thermocompression bonding film from the printing device 71 in a state that the packing material 90 is supported by the paper mounting section 74 of the packing device 72 and finishes outputting the output paper 80, the document output device 70 further discharges the thermocompression bonding film from the printing device 71. Then, the thermocompression bonding film sandwiched between the output paper 80 and the packing material 90 and pressure is added thereto from the outside of the packing material 90 as maintaining a predetermined temperature so as to bond each of the output paper 80 of the uppermost layer and output paper 80 of the lowest layer to the packing material 90 by the thermocompression bonding section. The packing device 72 further includes a stock section 79 that stocks a package 81 (one in which output paper 80 is packed by a bag 91 made of packing material 90), and a transferring section that transfers the package 81 to the stock section 79. The transferring section transfers the package 81 to the stock section 79 by control of the control section of the packing device 72. Additionally, in order to take out the package 81 from the stock section 79, an opening and closing section of the stock section 79 is opened by a dedicated key. The key is stored by the store where the document output device 70 is setup.

A series of operations by the packing device 72 is controlled by the control section provided in the packing device 72. The control section of the packing device 72 is connected to the control section of the printing device 71 via an interface.

(Processing Steps for Printing)

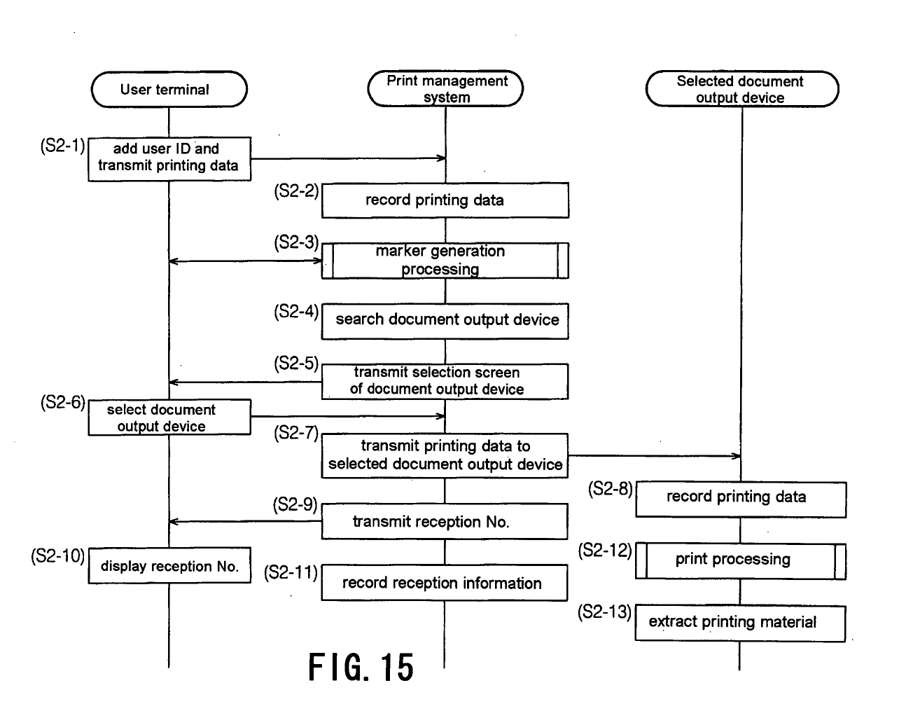

An explanation will be next given of processing (printed matter generation processing) steps when the document output device 70 selected by the user executes printing and packing based on the print request from the user terminal 31 in the above-configured system according to FIG. 15.

In the case of printing an electronic file, the user first performs an operation of a print request using the user terminal 31 according to an instruction screen. When the print request is made, the user terminal 31 converts the printing electronic file to print data by a printer driver. A header of print data includes, for example, designation of a model of a printer (document output device) corresponding to the printer driver that generated print data and designation of whether a single-side printing or a double-side printing should be executed. The user terminal 31 adds a user ID to the print data and transmits the result to the print management system 29 (step S2-1). The control section 261 of the management computer 26 of the print management system 29 receives this print data. The control section 261 stores this print data in the storing section 262 (step S2-2).

The control section 261 of the management computer 26 executes identification marker generation processing between the user terminal 31 and the control section 261 (step S2-3). More specifically, the control section 261 executes processing explained in the first embodiment to generate data of the identification marker where the designated identifier is embedded in the designated identifier arranging area. Next, the control section 261 obtains information of latitude and longitude of a user current location and searches the printable document output devices 70 within a predetermined distance from the user current location (step S2-4). More specifically, in the case where a GSP function is installed on the user terminal 31, position information obtained by the GSP function is transmitted to the management computer 26 from the user terminal 31. The control section 261 of the management computer 26 specifies user latitude and longitude based on transmitted position information. While, in the case where a GSP function is not installed on the user terminal 31, the control section 261 receives information of the input current location and obtains latitude and longitude from the received data on a web page for inputting the user current location. Then, the control section 261 extracts output destination data 240 of the document output device 70, which is positioned in the range of the predetermined distance from the user, based on latitude and longitude of the location in the output destination data 240 and the specified user latitude and longitude. Then, the control section 261 specifies the designation of the model included in the header of the received print data, the model indicated by the extracted output designation data 240 and the document output device 70 that can print the received print data.

The control section 261 of the management computer 26 transmits data for displaying information of the specified document output device 70 to the user terminal 31 (step S2-5). When receiving this data, the user terminal 31 displays a searching result screen showing information of the searched document output device 70. On the searching result screen, a map showing the neighborhood of the user and a list of the searched document output devices 70 are displayed. On the map showing the neighborhood of the user, the user current location and the position of the store where the searched document output device 70 is set up are displayed based on the specified user current location, the location of the output destination data 240. In the list of the document output devices 70, the name of the store where the document output device 70 is set up and the model of the document output device 70 are displayed in connection with each searched document output device 70. When the user decides the document output device 70 that causes printing to be executed and inputs selection, the user terminal 31 transmits selection data of the selection of the document output device 70 to the management computer 26 accordingly (step S2-6). The selection data includes the user ID and the IP address of the selected document output device 70.

The control section 261 of the management computer 26 that received selection data adds a reception number to the received data. The control section 261 transmits print data to which the reception number, the user ID, the user name, identification marker data are added to the IP address of the selected document output device 70 (step S2-7). The document output device 70 that received the print data records the reception number, the user ID, the user name, identification marker data and print data in the storing section of the document output device 70 (step S2-8).

Moreover, the control section 261 of the management computer 26 transmits the reception number to the user terminal 31 (step S2-9). The user terminal 31 that received the reception number displays the reception number (step S2-10). Moreover, the control section 261 of the management computer 26 records reception data 250 in the reception data storing section 25 (step S2-11). More specifically, the control section 261 records the reception number and the user ID of the reception data 250 based on the reception number and the user ID added to the print data. Furthermore, the control section 261 records the IP address of the output destination of reception data 250 based on the IP address of the document output device 70 of the transmission destination of print data. Moreover, the control section 261 records data of the reception time of the reception data 250 based on date and time when the control section 261 received the selection data. After that, the control section 261 deletes print data recorded in step S2-2 from the storing section 262.

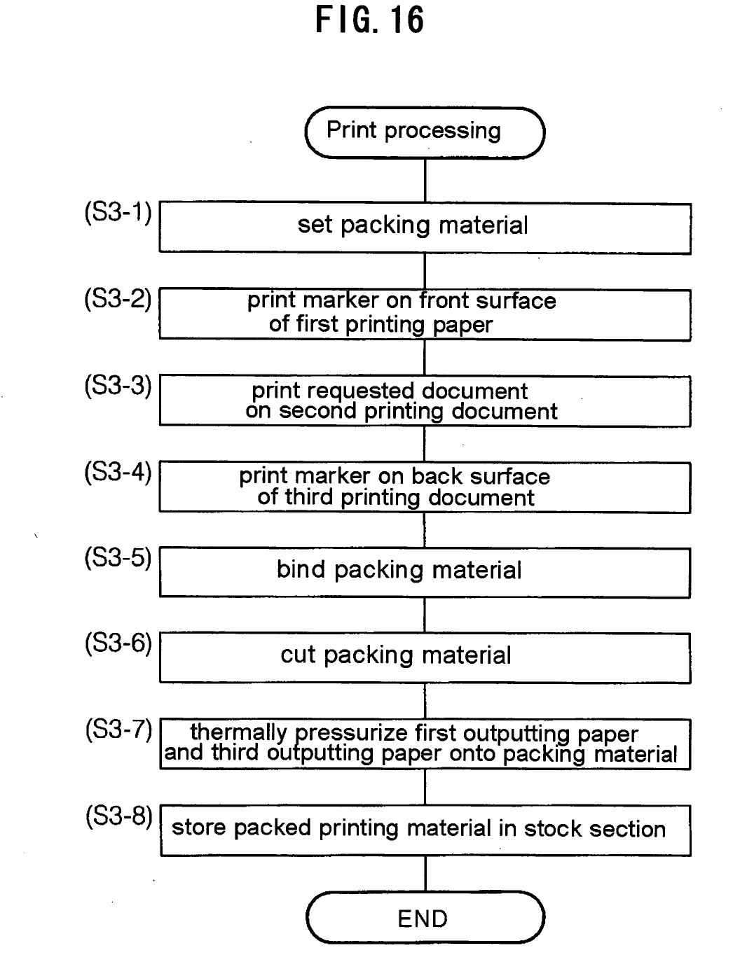

While, the document output device 70 executes print processing based on the print data, the reception number, the user ID, the user name, the identification marker data recorded in step S2-8 (step S2-12). The print processing will be explained using FIG. 16.

As illustrated in FIG. 16, the document output device 70 that received the print data first sets packing material (step S3-1). More specifically, when the document output device 70 receives the print data, the control section of the printing device 71 notifies the control section of the packing device 72 of the reception of the print data. The control section of the packing device 72 that received the notification drives the feeding rollers 75 by the feeding roller control motor, and the packing material 90 is fed to the paper mounting section 74 by the feeding rollers 75. Moreover, the control section of the printing device 71 controls airflow to be blown from the nozzles. Accordingly, as mentioned above, the top end of the packing material 90 to be fed is opened by the airflow blown from the nozzles. Then, the packing material 90 is transferred to the discharge port 73 along the inner wall surface of the paper mounting section 74. When the packing material 90 is fed to the position where the top end of the packing material 90 comes in contact with the second heaters 77, the feeding roller control motor stops the feeding rollers 75. Then, the control section of the packing device 72 supplies negative pressure to the first sucking section of the first heaters 76 and the second sucking section of the second heaters 77, respectively. Accordingly, the packing material 90 is supported in such a way to be sucked by the first and second sucking sections. When the packing material is set in this way, the control section of the packing device 72 notifies the control section of the printing device 71 of a packing material setting completion.

The printing device 71 can execute double-side printing, and outputs the output paper 80 to the paper mounting section 74 in such a way that the front side surface of the output paper 80 is directed downward. Then, when the printing device 71 outputs multiple output papers 80, the output papers 80 are piled on top of one another. Regarding the piled output papers 80, the face directing downward becomes the surface of the output paper 80 that was first output and the face directing upward becomes the back surface of the output paper 80 that was output last.

When receiving the notification of setting completion from the packing device 72, the printing device 71 discharges the thermocompression bonding film to the paper mounting section 74. The printing device 71 prints the reception number, the user ID, the user name and the identification marker onto the front surface of a first printing paper (step S3-2). More specifically, the printing device 71 prints each of the reception number, the user ID, the user name and the identification marker at a predetermined position based on the reception number, the user ID, the user name and the identification marker that are recorded in the storing section. Additionally, the first printing is the printing paper of the output paper 80 that is first output according to the print request. After that, the printing device 71 discharges the output paper 80 as the first output paper on which these data items are printed. Next, the printing device 71 prints a document (request document) subjected to the print request on a second printing paper based on the print data (step S3-3). The printing device 71 discharges the output paper 80 as the second output paper where the request document is printed to the paper mounting section 74 one by one. Additionally, in the present embodiment, the same kind of printing paper as that of the first printing paper is used as the second printing paper. Accordingly, in the present embodiment, the second printing paper is fed from a paper feed tray where the first printing paper is fed.

Additionally, in the present embodiment, both one side printing and double side printing can be performed to the request document. The printing device 71 performs printing according to the designation of one side printing or double side printing. Then, when finishing printing the request document and discharging to the paper mounting section 74, the printing device 71 performs printing to the back surface of a third printing paper. More specifically, the printing device 71 prints the reception number, the user ID, the user name and the identification marker on the back surface of the third printing paper (step S3-4). Then, the printing device 71 discharges the output paper 80 as the third output paper on which these items are printed to the paper mounting section 74. The output paper 80 is piled on the output papers 80 stacked on the paper mounting section 74 in a state that the back surface is directed upward. Accordingly, the surface directing to the upper side of the output papers 80 stacked on the paper mounting section 74 becomes the surface on which the reception number, the output papers 80 stacked on the paper mounting section 74 user ID, the user name and the identification marker are printed.

Then, the printing device 71 discharges the thermocompression bonding film to the paper mounting section 74. The thermocompression bonding film is piled on the output papers 80 stacked on the paper mounting section 74. Then, the control section of the printing device 71 notifies the control section of the packing device 72 of a print end.

The control section of the packing device 72 that received the notification of the print end performs processing for binding the packing material (step S3-5). More specifically, the control section of the packing device 72 binds the packing material 90 by heating as making the first heaters 76 come close to each other by a first heater moving motor. Moreover, the control section of the packing device 72 binds the packing material 90 by heating as making the second heaters 77 come close to each other by a second heater moving motor. In the present embodiment, at the time of binding the packing material 90, the output paper 80 and the packing material 90 are adhered to each other. Then, the control section of the packing device 72 stops the supply of negative pressure to the second sucking section. After that, the control section of the packing device 72 separates the second heaters 77 from each other by a second heater drive motor. Next, the control section of the packing device 72 performs processing for cutting the packing material (step S3-6). More specifically, the control section of the packing device 72 operates the cutter 78 to cut the packing material 90 between the portion bound by the first heaters 76 and the feeding rollers 75. Accordingly, the bag 91 in which the output paper 80 is enclosed is separated from the roll-like packing material 90. Then, the control section of the packing device 72 separates the first heaters 76 from each other by the first heater motor.

Next, the control section of the packing device 72 performs processing for thermocompression bonding the front surface of the first output paper and the back surface of the third output paper to the packing material 90, respectively (steps S3 to S7). More specifically, the control section of the packing device 72 operates the thermocompression bonding section to heat up to a predetermined temperature as pressing the output paper 80 sandwiched by the packing material 90 of the bag 91. Accordingly, the front surface of the first output paper and the back surface of the third output paper are adhered to the packing material 90, respectively. Next, the control section of the packing device 72 executes control for storing the packed output papers 80 to the stock section 90 (steps S3 to S8). More specifically, the control section of the packing device 72 causes the transferring section to transfer the package 81 to the stock section 79. Accordingly, the package 81 is stored in the stock section 79. Then, the control section of the packing device 72 sends a packing completion notification to the control section of the printing section 71.

On the other hand, the printing section 71 deletes data of the reception number, the user ID, the user name and the identification marker stored in the storing section of the document output device 70 in connection with the print request in which print processing is ended.

Then, the user goes to the store where the selected document output device 70 is set up and tells a salesclerk the user ID and the reception number to request him/her to take out the package 81. The salesclerk opens the open/close section of the stock section 79 using the dedicated key dedicated to the open/close section of the stock section 79. The salesclerk checks the user ID and the reception number given by the user against the user ID and the reception number printed on the outside surface of the package 81, and takes out a matching package 81 from the stock section 79 of the document output device 70 (steps S2 to S13). Then, the salesclerk sends the package 81 taken out from the stock section 79 to the user in exchange for the money for printing. Regarding the package 81, the reception number, the user ID, the user name, and the identification marker can be confirmed from the outside. The user can confirm that the identifier designated by the user is displayed at the position designated by the user in connection the identification marker.

As mentioned above, according to the second embodiment, the following effects can be obtained in addition to the effects obtained by the first embodiment. Namely, in the aforementioned embodiment, the management computer 26 transmits the user ID and etc. of the user, who designated the identifier and the identifier arranging area, to the document output device 70 together with the print data in association with the identification marker data. The document output device 70 can print the user ID and etc. and the identification marker. Accordingly, the salesclerk can specify the user using the user ID and etc., while the user can confirm the printed matter printed by his/her print request based on the user ID and etc. and the identification marker.

Moreover, in the aforementioned embodiment, the document output device 70 outputs the output paper 80 (first output paper) with the user ID and etc. and the identification marker printed on the front surface. Then, the output paper 80 (second output paper) on which the request document by the print request is printed is piled thereon. Moreover, the output paper 80 (third output paper) with the user ID and etc. and the identification marker printed on the back surface is piled thereon. The first output paper and the third output paper are thermocompression bonded to the packing material 90, respectively, so that the first output paper and the third output paper are combined with the packing material 90. Then, the second output paper sandwiched between the first output paper and the third output paper is packed by the bag 91 where the first output paper and the third output paper are combined with each other. For this reason, the bag 91, which is combined with the output paper on which the user ID and etc. and the identification marker are printed and is unique to each print request, is used as the package 81 of the printed request document. Since the package 81 is formed such that the vinyl packing material 90 and the output paper 80 are adhered to each other, it is difficult to perform repacking by use of the bag 91 to open.

Furthermore, since it is difficult for the third person excepting the user, who designated the identifier and the identifier arranging area, to grasp the identifier arranging area, there is difficulty in generating data for printing the same arrangment for a short time by use of the other computer terminal separately. Accordingly, even if data for printing the user ID and etc. can be easily generated by use of the other computer terminal separately, it is difficult to generate data for printing the identification marker. This makes it possible for the other person to prevent from printing of these data items to generate the package separately.

Additionally, in the aforementioned embodiment, the following changes in the embodiments may be possible. Namely, in the first and second embodiments, symbols are randomly extracted from the symbolic group data 220 of the category where the symbols that form the designated identifier belong and the extracted symbols are arranged in the portion excepting the identifier arranging area. In place of this, the management computers 21 and 26 present symbols belonging to the same category where the symbols that form the identifier belong, encourages the user to select the symbols to be arranged in the portion excepting the identifier arranging area, so that the selected symbols may be arranged in the portion excepting the identifier arranging area. This makes it possible to use only the symbols selected by the user to be arranged in the portion excepting the identifier arranging area.

In the first and second embodiments, the characters that are specified by the character code are used as symbols that form the identifier, and the designation of the identifier is executed by the user's direct input using the keyboard and the like. In place of this, the symbols that form the identifier may be images such as graphics and the like. Moreover, the designation of the identifier by the user may be executed by presenting designatable images to cause the user to select an appropriate image. In this case, the respective images may be classified into the categories of the relevant images. For example, in the case of using a character pattern of a story as a symbol that forms the identifier, a character appearing in the same story may be classified in the same category. This makes it possible for the user himself/herself, who designated the identifier and the identifier arranging area, to memorize the identifier and the like more easily. Moreover, this can be simply looked like a pattern to the persons excepting the user himself/herself. Furthermore, expression of the character may be used as an identifier. For example, a specific expression of the character is used as an identifier and the same character with a different expression may be placed in the other portion of the identification marker. In this case, this also makes it possible for the user himself/herself, who designated the identifier and the identifier arranging area, to memorize the identifier and the like more easily. Moreover, this can be simply looked like a pattern to the persons excepting the user himself/herself.

In the first and second embodiments, the size in symbol is set to the predetermined fixed size. In place of this, the size in symbol may be decided based on the number of symbols that form the identifier. In this case, the management computers 21 and 26 decide the number of symbols that fill the identification marker in such a way the ratio between the symbols that form the identifier and the other symbols reaches a predetermined ratio. Additionally, the number of symbols that fill the identification marker is set to the number of symbols that is used when the identification marker with a predetermined size is filled with symbols whose aspect ratio is fixed. Then, the management computers 21 and 26 present squares corresponding to the number of symbols on the designation screen of the identifier arranging area. The management computers 21 and 26 adjust the size in the symbols that form the identification marker in such a way that the identification marker can be arranged with a predetermined size. This makes it possible for the user himself/herself, who designated the identifier and etc., to easily identify the identifier according to the number of symbols that form the identifier.

Furthermore, full-size characters may be used as an identifier. In this case, the management computers 21 and 26 determine whether the designated identifier is the full-size characters or half-size characters, and generate an identification marker where the characters belonging to the same category where the identifier belongs are arranged in the portion excepting the identifier arranging area. Moreover, the identifier may be designated in such a way that full-size symbols and half-size symbols are mixed. In this case, the management computers 21 and 26 present squares corresponding to the half-size symbols on the identifier arranging area designation screen. When the start position of the identifier is designated, the management computers 21 and 26 adjust the start position so that all squares are filled with the symbols (no vacant square occurs). The management computers 21 and 26 make the full-size symbols and half-size symbols belong to the different categories, respectively, and extract symbols to be arranged in the portion excepting the identifier arranging area from the respective categories according to the ratio for each category where the symbols that form the identifier belong. This makes it possible for the user to freely designate the full-size symbols and half-size symbols as the identification marker. Furthermore, the ratio between the full-size symbols and half-size symbols to be arranged in the portion excepting the identifier arranging area can be the same as the ratio between the full-size symbols and half-size symbols that form the identifier. In this case, this makes it difficult for the persons excepting the user himself/herself, who designated the identifier, to recognize the identification marker.

In the first and second embodiments, data of the symbols used in the identification marker is prerecorded in the symbolic data storing section 22. In addition to this, data of the symbols used in the identification marker may be newly registered in the symbolic data storing section 22. This makes it possible to increase the number of symbols for generating the identification marker.

In the first and second embodiments, the identification marker is printed. However, the identification marker may be displayed on the display of a mobile terminal and the like. For example, in the case of using the multiple similar items, a display is provided to each item, and the identification marker may be displayed on the display. Accordingly, for example, even when many persons use the similar items, the same identification marker can be displayed in connection with the item that the same person uses for a fixed time period. In the case where the same item is used many times, the printed matter on which the identification marker is printed does not have to be output for each time.

In the first and second embodiments, the management computer 21 generates an identification marker upon reception of the designation of the identifier and the identifier arranging area from the user terminal 31 via the network 30. In place of this, the identification marker may be uniquely generated by computers such as a personal computer that the user uses, a PDA, a special purpose machine, and etc. In this case, the computer used by the user includes the respective sections that the management computers of the aforementioned embodiments have, and generates the identification marker. This makes it possible to uniquely generate an identification marker upon reception of the designation of the identifier and the identifier arranging area and print the identification marker.

In the second embodiment, the output paper 80 is packed using the vinyl packing material 90 and the first output paper and the third output paper are thermocompression bonded to the packing material 90, respectively, to generate the package 81. However, any packing material may be used if the package of the printed matter by the print request is one that cannot be easily restored to the original state and the printed matter on which the identification marker is printed cannot reused when the package is opened. For example, by use of packing material that cannot be packed again in the same form after opening the packing material, a seal on which the user ID and etc. and the identification marker are printed may be adhered onto the packing material. Moreover, in order to prevent the seal from being copied and used, printing such that a pattern embedded in the printed matter is embossed when copying is performed may be executed to the identification marker portion of the seal.

In the second embodiment, the document output device 70 is one that is set up in the convenience store and the like and used in public. However, the document output device 70 may not be one that is used in public. For example, a printer as the document output device may be set up in the building of the company and a specific user such an employee may be used the printer.

In the second embodiment, the identification marker and the user ID and etc. are printed in the case of printing the request document from the user. However, the present invention is not limited to this. The identification marker and user identification information may be printed in the other case (case other than the printing of the request document). This makes it possible for the person excepting, the user, who designated the identifier and etc., to specify the user based on the user ID and etc. Moreover, this makes it possible for the user, who designated the identifier and etc., to confirm that the relevant item belongs to the user based on the identification marker.

As a storage medium that stores a program and data for implementing the identification marker generating function, a CD-ROM (-R/-RW), a magneto-optical disk. A DVD-ROM, an FD, a flash memory, a memory card, a memory stick, and the other various kinds of ROM and RAM may be used. Then, it is possible to configure the management computer that executes the aforementioned processing by distributing the storage medium to install the program and the like onto the computer. Furthermore, the program and the like may be stored in a disk device, which a server apparatus on a network such as the Internet has, and superimposed on a carrier wave and downloaded on the computer.

Moreover, in the case where the aforementioned function is implemented by OS or the cooperation of OS and an application, part other than OS may be stored in the storage and distributed, and superimposed on the carrier wave and downloaded onto the computer.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2003-378769 filed on Nov. 7, 2003 and including specification, claims, drawings and summary. The disclosure of the above Japanese Patent Application is incorporated herein by reference in its entirety.

1. An identification marker generating apparatus, comprising:
an identifier designating section that receives designation of an identifier formed by symbols;
an identifier arranging area designating section that receives designation of an identifier arranging area of a symbol arranging area;
an arranging section that arranges the designated identifier in the designated identifier arranging area of the symbol arranging area;
an extracting section that extracts symbols belonging to the same category where the symbols that form the identifier belong from a database where the symbols belonging to the same category are stored to be associated with each other;
a generating section that generates an identification marker by arranging the extracted symbols in a portion excepting the identifier arranging area of the symbol arranging area; and
an outputting section that outputs the generated identification marker.

2. The identification marker generating apparatus according to claim 1, wherein said identifier designating section presents designatable symbols to a user to encourage the user to designate the identifier.

3. The identification marker generating apparatus according to claim 1, wherein said identifier arranging area designating section receives designation of a start position of the identifier in the symbol arranging area and specifies the identifier arranging area based on the start position of the designated identifier.

4. The identification marker generating apparatus according to claim 1, wherein said generating section presents the symbols extracted by said extracting section to the user to encourage the user to select symbols to be arranged in a portion excepting the identifier arranging area of the symbol arranging area, and arranges the selected symbols in the portion excepting the identifier arranging area.

5. The identification marker generating apparatus according to claim 1,
wherein said identifier arranging area designating section receives designation of multiple identifier arranging areas, and
wherein said arranging section arranges the identifier in the designated multiple identifier arranging areas.

6. The identification marker generating apparatus according to claim 1, wherein the symbols include at least one of characters and graphics.

7. The identification marker generating apparatus according to claim 1, wherein said outputting section outputs data for printing the identification marker.

8. The identification marker generating apparatus according to claim 1, wherein said outputting section outputs user identification information of the user, who designated the identifier, to be associated with the identification marker.

9. An identification marker generating apparatus, comprising:
identifier designating means for receiving designation of an identifier formed by symbols;
identifier arranging area designating means for receiving designation of an identifier arranging area of a symbol arranging area;
arranging means for arranging the designated identifier in the designated identifier arranging area of the symbol arranging area;
extracting means for extracting symbols belonging to the same category where the symbols that form the identifier belong from a database where the symbols belonging to the same category are stored to be associated with each other;
generating means for generating an identification marker by arranging the extracted symbols in a portion excepting the identifier arranging area of the symbol arranging area; and
outputting means for outputting the generated identification marker.

10. An identification marker generating method for generating data of an identification marker including an identifier using a computer, comprising the steps of:
receiving designation of an identifier formed by symbols;
receiving designation of an identifier arranging area of a symbol arranging area;
arranging the designated identifier in the designated identifier arranging area of the symbol arranging area;
extracting symbols belonging to the same category where the symbols that form the identifier belong from a database where the symbols belonging to the same category are stored to be associated with each other;
generating an identification marker by arranging the extracted symbols in a portion excepting the identifier arranging area of the symbol arranging area; and
outputting the generated identification marker.

11. A computer-readable storage medium having a program recorded thereon, said program causing a computer to execute the steps of:
receiving designation of an identifier formed by symbols;
receiving designation of an identifier arranging area of a symbol arranging area;
arranging the designated identifier in the designated identifier arranging area of the symbol arranging area;
extracting symbols belonging to the same category where the symbols that form the identifier belong from a database where the symbols belonging to the same category are stored to be associated with each other;
generating an identification marker by arranging the extracted symbols in a portion excepting the identifier arranging area of the symbol arranging area; and
outputting the generated identification marker.

12. A computer data signal embedded in a carrier wave indicating a program causing a computer to execute the steps of:
receiving designation of an identifier formed by symbols;
receiving designation of an identifier arranging area of a symbol arranging area;
arranging the designated identifier in the designated identifier arranging area of the symbol arranging area;
extracting symbols belonging to the same category where the symbols that form the identifier belong from a database where the symbols belonging to the same category are stored to be associated with each other;
generating an identification marker by arranging the extracted symbols in a portion excepting the identifier arranging area of the symbol arranging area; and
outputting the generated identification marker.
